(19) United States
(12) Patent Application Publication
(10) Pub. No.: US 2018/0269482 A1
(43) Pub. Date: Sep. 20, 2018

(54) POSITIVE ELECTRODE ACTIVE MATERIAL, POSITIVE ELECTRODE USING THE SAME, AND LITHIUM ION SECONDARY BATTERY

(71) Applicant: TDK CORPORATION, Tokyo (JP)

(72) Inventor: Shin FUJITA, Tokyo (JP)

(73) Assignee: TDK CORPORATION, Tokyo (JP)

(21) Appl. No.: 15/912,720

(22) Filed: Mar. 6, 2018

(30) Foreign Application Priority Data
Mar. 17, 2017 (JP) 2017-052387
Dec. 25, 2017 (JP) 2017-247391

(51) Int. Cl. H01M 4/58; H01M 10/0525; H01M 10/0569; C01B 25/45

(52) U.S. Cl. CPC H01M 4/5825; H01M 10/0525; H01M 2004/028; C01B 25/45; H01M 10/0569

(57) ABSTRACT

A positive electrode active material includes a compound represented by general formula (1) below. The compound contains crystallization water.

LiₐM_{b}(PO₄)_{c} ρ (1)

(M includes at least one selected from Fe, Mn, Co, Ni, VO, V, and 1 [symbol] a [symbol] 4, 1 [symbol] b [symbol] 2, 1 [symbol] c [symbol] 3)

### CROSS-REFERENCE TO RELATED APPLICATION

This application claims priority from Japanese Patent Application Nos. 2017-052387 filed on Mar. 17, 2017, and 2017-247391 filed on Dec. 25, 2017 with the Japan Patent Office, the entire contents of which are hereby incorporated by reference.

### BACKGROUND

### 1. Technical Field

The present disclosure relates to a positive electrode active material, a positive electrode using the same, and a lithium ion secondary battery.

### 2. Description of the Related Art

Typically, layered compounds such as LiCoO₂ and LiNi_{1/3}Mn_{1/3}Co_{1/3}O₂ and spinel compounds such as LiMn₂O₄ have been used as a positive electrode material (positive electrode active material) of the lithium ion secondary battery. In recent years, attention has been paid to a compound having an olivine structure represented by LiFePO₄. It is known that the positive electrode material having an olivine structure has high thermal stability at a high temperature and high safety.

However, the lithium ion secondary battery using LiFePO₄ has a disadvantage that energy density is low because its charge/discharge voltage is as low as about 3.5 V. Therefore, LiCoPO₄, LiNiPO₄ and the like have been proposed as a phosphate-based positive electrode material capable of realizing a high charge/discharge voltage. However, at present, sufficient cycle characteristics are not obtained even in the lithium ion secondary battery using these positive electrode materials. Among the phosphate-based positive electrode materials, LiVOPO₄ is known as a compound capable of realizing charge/discharge voltage of 4 V class (J. Baker et al. J. Electrochem. Soc., 151, A796 (2004)).

However, even in the lithium ion secondary battery using LiVOPO₄, sufficient high-temperature storage characteristics and cycle characteristics have not been obtained. In the following, the lithium ion secondary battery is referred to as a ‘battery_in some cases.

### SUMMARY

A positive electrode active material includes a compound represented by general formula (1) below. The compound contains crystallization water.

LiₐM_{b}(PO₄)_{c} ρ (1)

(M includes at least one selected from Fe, Mn, Co, Ni, VO, V, and 1 [symbol] a [symbol] 4, 1 [symbol] b [symbol] 2, 1 [symbol] c [symbol] 3)

### BRIEF DESCRIPTION OF THE DRAWINGS

FIG. 1 is a schematic cross-sectional view of a lithium ion secondary battery according to the present embodiment.

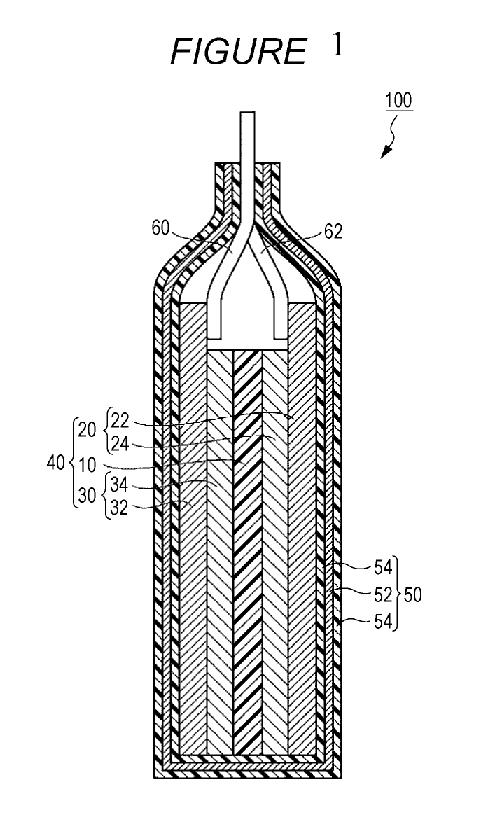

### DESCRIPTION OF THE EMBODIMENTS

In the following detailed description, for purpose of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

An object of the present disclosure is to provide a positive electrode active material, a positive electrode and a lithium ion secondary battery capable of improving high-temperature storage characteristics and cycle characteristics of a lithium ion secondary battery.

A positive electrode active material according to an aspect of the present disclosure includes a compound represented by general formula (1) below. The compound contains crystallization water.

LiₐM_{b}(PO₄)_{c} ρ (1)

(M includes at least one selected from Fe, Mn, Co, Ni, VO, V, and 1 [symbol] a [symbol] 4, 1 [symbol] b [symbol] 2, 1 [symbol] c [symbol] 3)

In the positive electrode active material having this configuration, crystallization water is contained in a polyanionic phosphate compound having a high thermal stability, so that reaction of crystallization water with electrolyte selectively occurs. Therefore, high-temperature storage characteristics and high-temperature cycle characteristics are improved.

In the positive electrode active material, content of crystallization water is preferably 0.001 to 0.2 wt %.

Since crystallization water of 0.001 wt % or more is contained in the positive electrode active material, above-described effects appear more remarkably. When the content of crystallization water in the positive electrode active material is 0.2 wt % or less, an excessive reaction of crystallization water with the electrolyte can be suppressed.

In the positive electrode active material, M in the general formula (1) is preferably VO.

According to embodiments of the present disclosure, it is possible to provide a positive electrode active material, a positive electrode using the same, and a lithium ion secondary battery having excellent high-temperature storage characteristics and rate characteristics.

A n example of a preferred embodiment of the lithium ion secondary battery according to the present disclosure will be described with reference to the drawing. It should be noted, however, that the lithium ion secondary battery according to the present disclosure is not limited to the following embodiments. The dimensional ratios of the drawing are not limited to the illustrated ratios.

### (Lithium Ion Secondary Battery)

The electrodes and the lithium ion secondary battery according to the present embodiment will be briefly described with reference to the FIGURE. The lithium ion secondary battery 100 is mainly provided with a stacked body 40, a case 50 housing the stacked body 40 in a sealed state, and a pair of leads 60, 62 connected to the stacked body 40. While not shown in the drawing, an electrolyte is also housed in the case 50 along with the stacked body 40.

In the stacked body 40, a positive electrode 20 and a negative electrode 30 are disposed opposite each other across a separator 10 containing a nonaqueous electrolyte. The positive electrode 20 includes a plate-like (film) positive electrode current collector 22, and a positive electrode active material layer 24 disposed on the positive electrode current collector 22. The negative electrode 30 includes a plate-like (film) negative electrode current collector 32 and a negative electrode active material layer 34 disposed on the negative electrode current collector 32. The positive electrode active material layer 24 and the negative electrode active material layer 34 are in contact with corresponding sides of the separator 10. To corresponding edge parts of the positive electrode current collector 22 and the negative electrode current collector 32, leads 62, 60 are connected. Edge parts of the leads 60, 62 are disposed outside the case 50.

In the following, the positive electrode 20 and the negative electrode 30 may be collectively referred to as the electrode 20, 30. The positive electrode current collector 22 and the negative electrode current collector 32 may be collectively referred to as the current collector 22, 32. The positive electrode active material layer 24 and the negative electrode active material layer 34 may be collectively referred to as the active material layer 24, 34.

The positive electrode active material layer 24 according to the present embodiment includes a positive electrode active material, a positive electrode binder, and a conductive material.

### (Positive Electrode Active Material)

The positive electrode active material according to the present embodiment is a compound represented by the general formula (1) below and contains crystallization water.

LiₐM_{b}(PO₄)_{c} ρ (1)

(In the above general formula (1), M includes at least one selected from Fe, Mn, Co, Ni, VO and V. Numbers a, b and c are such that 1 [symbol] a [symbol] 4, 1 [symbol] b [symbol] 2, 1 [symbol] c [symbol] 3.)

In the positive electrode active material having this configuration, crystallization water is contained in the polyanionic phosphate compound having a high thermal stability, so that the reaction of crystallization water with the electrolyte selectively occurs. Therefore, high-temperature storage characteristics and high-temperature cycle characteristics are improved.

The positive electrode active material according to the present embodiment preferably has a content of crystallization water of 0.001 to 0.2 wt %.

Since crystallization water of 0.001 wt % or more is contained in the positive electrode active material, the above-described effects appear more remarkably. When the content of crystallization water in the positive electrode active material is 0.2 wt % or less, an excessive reaction of crystallization water with the electrolyte can be suppressed.

In the positive electrode active material according to the present embodiment, M in the general formula (1) is preferably VO.

The amount of crystallization water in the positive electrode active material according to the present embodiment can be determined, for example, by removing adsorbed water adhering to the positive electrode active material at a temperature of 120 to 170° C. and then by measuring the positive electrode active material by the Karl Fischer method at a temperature of 300° C. or higher. It should be noted that it is possible to distinguish between adsorbed water and crystallization water by measuring and removing the adsorbed water at a temperature of 120 to 170° C. by the Karl Fischer method and then by measuring crystallization water at a temperature of 300° C. or higher by the Karl Fischer method.

An average primary particle size of the positive electrode active material according to the present embodiment is preferably 150 to 600 nm. Thus, Li conductivity is improved, so that high rate characteristics can be obtained.

### (Positive Electrode Current Collector)

The positive electrode current collector 22 may be a plate of conductive material. For example, as the positive electrode current collector 22, a metal thin plate with an aluminum, copper, or nickel foil may be used.

### (Positive Electrode Binder)

The binder binds the active materials and also binds the active materials with the current collector 22. The binder may be any binder capable of achieving the above binding. Examples of the binder include fluorine resin such as polyvinylidene fluoride (PVDF), polytetrafluoroethylene (PTFE), tetrafluoroethylene/hexafluoropropylene copolymer (FEP), tetrafluoroethylene/perfluoro alkyl vinyl ether copolymer (PFA), ethylene/tetrafluoroethylene copolymer (ETFE), polychlorotrifluoroethylene (PCTFE), ethylene/chlorotrifluoroethylene copolymer (ECTFE), and polyvinyl fluoride (PVF).

Other than the above examples, vinylidene fluoride fluorine rubber may be used as the binder. Examples of fluorine rubber based on vinylidene fluoride include fluorine rubber based on vinylidene fluoride/hexafluoropropylene (VDF/HFP-based fluorine rubber), fluorine rubber based on vinylidene fluoride/hexafluoropropylene/tetrafluoroethylene (VDF/HFPTFE-based fluorine rubber), fluorine rubber based on vinylidene fluoride/pentafluoropropylene (VDF/PFP-based fluorine rubber), fluorine rubber based on vinylidene fluoride/pentafluoropropylene/tetrafluoroethylene (VDF/PFP/TFE-based fluorine rubber), fluorine rubber based on vinylidene fluoride/perfluoromethyl vinyl ether/tetrafluoroethylene (VDF/PFMVE/TFE-based fluorine rubber), and fluorine rubber based on vinylidene fluoride/chlorotrifluoroethylene (VDF/CT FE-based fluorine rubber).

As the binder, a conductive polymer having electronic conductivity or conductive polymer having ion conductivity may be used. An example of the conductive polymer having electronic conductivity is polyacetylene. In this case, the binder will also serve as conductive material, so that other conductive material may not be added. An example of the conductive polymer having ion conductivity is a composite of polymer compound, such as polyethylene oxide or polypropylene oxide, and a lithium salt or an alkali metal salt based on lithium.

### (Conductive Material)

Examples of the conductive material include carbon powder of carbon black and the like; carbon nanotube; carbon material; metal fine powder of copper, nickel, stainless steel, or iron; a mixture of carbon material and metal fine powder; and a conductive oxide, such as ITO.

### (Negative Electrode Active Material Layer)

The negative electrode active material layer according to the present embodiment includes a negative electrode active material, a negative electrode binder, and a conductive material.

### (Negative Electrode Active Material)

The negative electrode active material may be a compound capable of lithium ion intercalation and deintercalation. As the negative electrode active material, known negative electrode active material for lithium-ion batteries may be used. As the negative electrode active material, substance capable of lithium ion intercalation and deintercalation may be used. Examples of such substance include carbon material such as graphite (natural graphite and synthetic graphite), carbon nanotube, hard carbon, soft carbon, and low temperature heat-treated carbon; metals that can be combined with lithium, such as aluminum, silicon, and tin; amorphous compound based on an oxide such as silicon dioxide and tin dioxide; and particles including lithium titanate (Li₄Ti₅O₁₂) or the like. The negative electrode active material may be graphite, which has high capacity per unit weight and is relatively stable.

### (Negative Electrode Current Collector)

The negative electrode current collector 32 may be a plate of conductive material. As the negative electrode current collector 32, a metal thin plate including aluminum, copper, or nickel foil may be used.

### (Negative Electrode Conductive Material)

Examples of the conductive material include carbon material such as carbon powder of carbon black and the like, and carbon nanotube; metal fine powder of copper, nickel, stainless, or iron; a mixture of carbon material and metal fine powder; and conductive oxide such as ITO.

### (Negative Electrode Binder)

As the binder used in the negative electrode, materials similar to those for the positive electrode may be used.

### (Negative Electrode Conductive Material)

The same conductive material that is used for the positive electrode may be used for the negative electrode.

### (Separator)

The material of the separator 10 may have an electrically insulating porous structure. Examples of the material include a single-layer body or stacked body of polyethylene, polypropylene, or polyolefin film; extended film of a mixture of the aforementioned resins; and fibrous nonwoven fabric including at least one constituent material selected from a group consisting of cellulose, polyester, and polypropylene.

### (Non-Aqueous Electrolyte)

The non-aqueous electrolyte includes electrolyte dissolved in non-aqueous solvent. The non-aqueous solvent may contain cyclic carbonate and chain carbonate.

As the cyclic carbonate, those capable of solvating the electrolyte can be used. The cyclic carbonate includes, for example, ethylene carbonate (EC), propylene carbonate (PC), and butylene carbonate.

A s the cyclic carbonate according to the present embodiment, propylene carbonate is preferably used. The reason is presumed as follows. That is, since propylene carbonate has a low boiling point to easily react with crystallization water at a high temperature, a coating film is promptly formed.

As the chain carbonate, those capable of lowering viscosity of the cyclic carbonate can be used. The chain carbonate includes, for example, diethyl carbonate (DEC), dimethyl carbonate (DMC), and ethyl methyl carbonate (EMC). In addition, a mixture of methyl acetate, ethyl acetate, methyl propionate, ethyl propionate, g-butyrolactone, 1, 2-dimethoxyethane, 1, 2-diethoxyethane and the like may be used as the chain carbonate.

As the cyclic carbonate according to the present embodiment, ethyl methyl carbonate is preferably used. The reason is presumed as follows. That is, it is possible to suppress increase in viscosity of nonaqueous electrolyte in particular, by using ethyl methyl carbonate. Therefore, since the reaction of crystallization water with the electrolyte is likely to occur, the coating film is promptly formed.

A ratio of the cyclic carbonate to the chain carbonate in a nonaqueous solvent is preferably in a range of 1:9 to 1:1 by volume. The ratio of the cyclic carbonate to the chain carbonate is more preferably in a range of 2:8 to 4:6 by volume.

Examples of the electrolyte include lithium salts such as LiPF₆, LiClO₄, LiBF₄, LiCF₃SO₃, LiCF₃, CF₂SO₃, LiC(CF₃SO₂)₃, LiN(CF₃SO₂)₂, LiN(CF₃CF₂SO₂)₂, LiN(CF₃SO₂)(C₄F₉SO₂), LiN(CF₃CF₂CO)₂, and LiBOB. Any of the lithium salts may be used individually, or two or more lithium salts may be used in combination. Particularly, from the viewpoint of electrical conductivity, the electrolyte may preferably include LiPF₆.

When LiPF₆ is dissolved in non-aqueous solvent, the concentration of the electrolyte in the non-aqueous electrolyte may be adjusted to 0.5 to 2.0 mol/L. When the electrolyte concentration is 0.5 mol/L or more, sufficient conductivity of the non-aqueous electrolyte can be ensured. As a result, sufficient capacity can be more readily obtained during charging/discharging. Further, by limiting the electrolyte concentration to 2.0 mol/L or less, an increase in the viscosity of the non-aqueous electrolyte can be suppressed, and sufficient lithium ion mobility can be ensured. As a result, sufficient capacity can be more readily obtained during charging/discharging.

When LiPF₆ is mixed with other electrolytes, the lithium ion concentration in the non-aqueous electrolyte may be adjusted to 0.5 to 2.0 mol/L. Of the lithium ions in the non-aqueous electrolyte, the lithium ions from LiPF₆ may have a concentration of 50 mol % or more.

### (Production Method of Positive Electrode Active Material)

A method of producing an active material according to an embodiment of the present disclosure will be described below. According to the method of producing the active material according to the present embodiment, the active material according to the present embodiment described above can be produced.

### <Hydrothermal Synthesis Step>

The method of producing the active material according to the present embodiment includes the following hydrothermal synthesis step. In the hydrothermal synthesis step, first, a lithium source, a phosphoric acid source, a transition metal source, water and a reducing agent are input into a reaction vessel (for example, an autoclave) having a function of heating and pressurizing its interior. Thus, a mixture (aqueous solution) in which they are dispersed is prepared. When the mixture is prepared, for example, a mixture of the phosphoric acid source, the transition metal source, water and the reducing agent may be first refluxed, and then the lithium source may be added to the mixture. By this reflux, a complex of the phosphoric acid source and a vanadium source can be formed.

As the lithium source, for example, at least one selected from a group consisting of LiNO₃, Li₂CO₃, LiOH, LiCl, Li₂SO₄ and CH₃COOLi can be used.

The lithium source is preferably at least one selected from a group consisting of LiOH, Li₂CO₃, CH₃COOLi and Li₃PO₄. This improves the rate characteristics of the battery as compared with a case of using Li₂SO₄.

As the phosphoric acid source, for example, at least one selected from a group consisting of H₃PO₄, NH₄H₂PO₄, (NH₄)₂HPO₄ and Li₃PO₄ can be used.

As the transition metal source, at least one selected from a group consisting of a divalent iron compound, a divalent manganese compound, a divalent cobalt compound, a divalent nickel compound and a vanadium source can be used.

As divalent compound, for example, at least one selected from a group consisting of iron fluoride, iron chloride, iron bromide, iron iodide, iron sulfate, iron phosphate, iron oxalate and iron acetate can be used.

As the divalent manganese compound, for example, at least one selected from a group consisting of manganese fluoride, manganese chloride, manganese bromide, manganese iodide, manganese sulfate, manganese phosphate, manganese oxalate and manganese acetate can be used.

As the divalent cobalt compound, for example, at least one selected from a group consisting of cobalt fluoride, cobalt chloride, cobalt bromide, cobalt iodide, cobalt sulfate, cobalt phosphate, cobalt oxalate, and cobalt acetate can be used.

As the divalent nickel compound, for example, at least one selected from a group consisting of nickel fluoride, nickel chloride, nickel bromide, nickel iodide, nickel sulfate, nickel phosphate, nickel oxalate and nickel acetate can be used.

A s vanadium compound, for example, at least one selected from a group consisting of vanadium oxide represented by V₂O₅ and ammonium vanadate can be used.

Note that two or more of lithium sources, two or more of phosphate sources, or two or more of transition metal sources may be used in combination.

As the reducing agent, for example, at least one selected from hydrazine (NH₂NH₂XH₂O) or hydrogen peroxide (H₂O₂), ascorbic acid, citric acid, tartaric acid, and aqueous ammonia can be used. Hydrazine is preferably used as the reducing agent. When the hydrazine is used, the rate characteristics of the battery tend to be remarkably improved as compared with a case where another reducing agent is used.

In the hydrothermal synthesis step, a ratio [P]/[M] of the number of moles [P] of phosphorus element contained in the mixture to the number of moles [M] of transition metal element contained in the mixture is adjusted to 0.9 to 1.1 before the mixture is heated under pressure. Even when the ratio [P]/[M] is greater than 1.1, effects of the present embodiment can be obtained. The ratio [P]/[M] can be adjusted by a blending ratio of the phosphoric acid source and the transition metal source contained in the mixture.

In the hydrothermal synthesis step, a ratio [Li]/[M] of the number of moles [Li] of lithium element contained in the mixture to the [M] can be adjusted to 0.9 to 1.1 before the mixture is heated under pressure. Even when the ratio [Li]/[M] is greater than 1.1, the effects of the present embodiment can be obtained. The ratio [Li]/[M] can be adjusted by a blending ratio of the lithium source and the transition metal source contained in the mixture.

As a method for adjusting pH of the mixture, various methods can be adopted, including, for example, a method of adding an acidic reagent or a basic reagent to the mixture. As the acidic reagent, nitric acid, hydrochloric acid, sulfuric acid or the like can be used. As the basic reagent, an aqueous ammonia solution or the like can be used. Incidentally, the pH of the mixture varies depending on an amount of the mixture, types or a blending ratio of the lithium source, the phosphoric acid source and the transition metal source. Therefore, an addition amount of the acidic reagent or the basic reagent can be appropriately adjusted according to the amount of the mixture, and the types or the blending ratio of the lithium source, the phosphoric acid source and the transition metal source.

In the hydrothermal synthesis step, the mixture in a sealed reactor is heated under pressure. This allows hydrothermal reaction to proceed in the mixture. Thus, LiₐM_{b}(PO₄)_{c} which is the active material is hydrothermally synthesized. It should be noted that time for heating the mixture under pressure can be appropriately adjusted according to the amount of the mixture.

In the hydrothermal synthesis step, the mixture is heated under pressure preferably at 100 to 300° C., more preferably 150 to 250° C. As heating temperature of the mixture is higher, crystal growth is promoted and the LiₐM_{b}(PO₄)_{c} having a larger particle size can be easily obtained. Further, as the heating temperature is lower, the content of crystallization water is increased.

When the temperature of the mixture in the hydrothermal synthesis step is too low, formation and crystal growth of the LiₐM_{b}(PO₄)_{c} tends not to proceed as compared with a case where the temperature of the mixture is high. As a result, crystallinity of the LiₐM_{b}(PO₄)_{c} is reduced and its capacity density decreases. Therefore, discharge capacity of the battery using the LiₐM_{b}(PO₄)_{c} tends not to increase.

When the temperature of the mixture is too high, crystal growth of the LiₐM_{b}(PO₄)_{c} proceeds excessively and diffusion ability of Li in the crystal tends to decrease. Therefore, the discharge capacity and the rate characteristics of the obtained battery using the LiₐM_{b}(PO₄)_{c} tend not to be improved. Further, when the temperature of the mixture is too high, the reaction vessel is required to have high heat resistance. As a result, production cost of the active material increases. These tendencies can be suppressed by setting the temperature of the mixture within the above range.

In the hydrothermal synthesis step, pressure applied to the mixture is preferably 0.2 to 1 MPa. When the pressure applied to the mixture is too low, the crystallinity of the finally obtained LiₐM_{b}(PO₄)_{c} is reduced and the capacity density tends to decrease. When the pressure applied to the mixture is too high, the reaction vessel is required to have high pressure resistance. As a result, production cost of the active material tends to increase. These tendencies can be suppressed by setting the pressure applied to the mixture within the above range.

### <Heat Treatment Step>

The method of producing an active material according to the present embodiment may include a heat treatment step of further heating the mixture after the hydrothermal synthesis step. In the heat treatment step, reaction of the lithium source, the phosphoric acid source and the transition metal source not reacted in the hydrothermal synthesis step is allowed to proceed, crystal growth of the LiₐM_{b}(PO₄)_{c} produced in the hydrothermal synthesis step can be promoted, and the amount of crystallization water can be adjusted. As a result, since the capacity density of the LiₐM_{b}(PO₄)_{c} is increased, the discharge capacity and the rate characteristics of the battery using the LiₐM_{b}(PO₄)_{c} tend to be improved.

In the present embodiment, when the mixture is heated in a high temperature range of 200 to 300° C. in the hydrothermal synthesis step, it is easy to form a sufficient size LiₐM_{b}(PO₄)_{c} in only the hydrothermal synthesis step. Further, in the present embodiment, even when the mixture is heated in a low temperature range of less than 200° C. in the hydrothermal synthesis step, it is possible to form a desired active material in only the hydrothermal synthesis step. However, when the mixture is heated in the low temperature range in the hydrothermal synthesis step, synthesis and crystal growth of the LiₐM_{b}(PO₄)_{c} is promoted by performing the heat treatment step following the hydrothermal synthesis step, so that the effects of the present embodiment tend to be further improved.

In the heat treatment step, the mixture is preferably heated at a heat treatment temperature of 350 to 700° C. When the heat treatment temperature is too low, degree of crystal growth of the LiₐM_{b}(PO₄)_{c} tends to be small, and degree of increase in the capacity density tends to decrease. When the heat treatment temperature is too high, the growth of the LiₐM_{b}(PO₄)_{c} proceeds excessively and the particle size of the LiₐM_{b}(PO₄)_{c} tends to increase. As a result, diffusion of the lithium in the active material tends to be slow, and the degree of increase in the capacity density of the active material tends to decrease. These tendencies can be suppressed by setting the heat treatment temperature within the above range.

Heat treatment time of the mixture can be 1 to 10 hours. Further, heat treatment atmosphere of the mixture can be a nitrogen atmosphere, an argon atmosphere, or an air atmosphere.

Note that the mixture obtained in the hydrothermal synthesis step may be preheated at about 60 to 150° C. for about 1 to 30 hours before heating in the heat treatment step. By preheating, the mixture turns into powders, and unnecessary moisture and organic solvent are removed from the mixture. As a result, impurities are suppressed from being incorporated into the LiₐM_{b}(PO₄)_{c} in the heat treatment step. As a result, particle shape can be made uniform.

### <Re-Hydrothermal Synthesis Step>

The method of producing the active material according to the present embodiment may further include a re-hydrothermal synthesis step after the heat treatment step. The content of crystallization water in the mixture obtained in the heat treatment step can be adjusted by performing hydrothermal synthesis again.

In the re-hydrothermal synthesis step, the mixture is heated under pressure preferably at 100 to 300° C., more preferably 150 to 250° C. As the heating temperature of the mixture is higher, the crystal growth is promoted and the LiₐM_{b}(PO₄)_{c} having a larger particle size can be easily obtained. Further, as the heating temperature is lower, the content of crystallization water is increased.

In the re-hydrothermal synthesis step, the hydrothermal reaction is allowed to proceed in the mixture by heating, under pressure, the mixture in the sealed reactor. This makes it possible to adjust the amount of crystallization water contained in the LiₐM_{b}(PO₄)_{c} which is the active material. It should be noted that the time for heating the mixture under pressure can be appropriately adjusted according to the amount of the mixture.

Further, heat treatment may be performed again after the re-hydrothermal synthesis step. This makes it possible to control the amount of crystallization water in the LiₐM_{b}(PO₄)_{c} which is the active material. Further, it is possible to remove impurities generated in the re-hydrothermal synthesis step and to improve the crystallinity of the active material itself.

The amount of crystallization water can be adjusted by adjusting the heat treatment temperature and the heat treatment time. The amount of crystallization water can be increased by lowering the heat treatment temperature or shortening the heat treatment time, and the amount of crystallization water can be reduced by increasing the heat treatment temperature or lengthening the heat treatment time.

In the battery provided with the LiₐM_{b}(PO₄)_{c} as the positive electrode active material, which is obtained by the production method of the present embodiment, the discharge capacity can be improved as compared with a battery using LiₐM_{b}(PO₄)_{c} obtained by the typical production method.

The active material obtained by the hydrothermal synthesis is usually dispersed in the solution after the hydrothermal synthesis. Therefore, liquid after the hydrothermal synthesis is a suspension. Then, a high purity active material containing LiₐM_{b}(PO₄)_{c} as a main component can be obtained by collecting solid, for example, by filtration of the liquid after the hydrothermal synthesis, and by washing the collected solid with water, acetone or the like, and then drying the washed solid.

A preferred embodiment of the method of producing the active material according to the present disclosure has been described in detail hereinabove. However, techniques of the present disclosure are not limited to the above embodiment.

For example, in the hydrothermal synthesis step, carbon particles may be added to the mixture before heating. Thus, at least a part of the LiₐM_{b}(PO₄)_{c} is formed on surfaces of the carbon particles. Therefore, the LiₐM_{b}(PO₄)_{c} can be supported on the carbon particles. As a result, it is possible to improve electrical conductivity of the obtained active material. Materials constituting the carbon particles include carbon black (graphite) such as acetylene black, and activated carbon, hard carbon, soft carbon and the like.

### (Method for Manufacturing Electrodes 20, 30)

A method for manufacturing the electrode 20 and 30 according to the present embodiment will be described.

The active material, binder, and solvent are mixed to prepare a paint. If necessary, conductive material may be further added. As the solvent, water or N-methyl-2-pyrrolidone may be used. The method of mixing the components of the paint is not particularly limited. The order of mixing is also not particularly limited. The paint is coated onto the current collectors 22 and 32. The coating method is not particularly limited, and a method typically adopted for electrode fabrication may be used. The coating method may include slit die coating and doctor blade method.

Thereafter, the solvent in the paint coating the current collectors 22 and 32 is removed. The removing method is not particularly limited, and may include drying the current collectors 22 and 32 with the paint coat thereon in an atmosphere of 80éC to 150éC.

The resulting electrodes with the positive electrode active material layer 24 and the negative electrode active material layer 34 respectively formed thereon are pressed by a roll press device or the like as needed. The roll press may have a linear load of 100 to 2500 kgf/cm, for example.

Through the above-described steps, there are obtained the positive electrode 20 including the positive electrode current collector 22 with the positive electrode active material layer 24 formed thereon, and the negative electrode 30 including the negative electrode current collector 32 with the negative electrode active material layer 34 formed thereon.

### (Method for Manufacturing Lithium Ion Secondary Battery)

In the following, a method for manufacturing the lithium ion secondary battery 100 according to the present embodiment will be described. The method for manufacturing the lithium ion secondary battery 100 according to the present embodiment includes a step of sealing, in the case (exterior body) 50, the positive electrode 20 and the negative electrode 30 including the above-described active materials, the separator 10 to be disposed between the positive electrode 20 and the negative electrode 30, and the nonaqueous electrolytic solution including lithium salt.

For example, the positive electrode 20 and the negative electrode 30 including the above-described active materials, and the separator 10 are stacked. The positive electrode 20 and the negative electrode 30 are heated and pressed from a direction perpendicular to the stacked direction, using a pressing tool. In this way, the stacked body 40 including the positive electrode 20, the separator 10, and the negative electrode 30 that are mutually closely attached is obtained. The stacked body 40 is then put into a pre-fabricated bag of the case 50, for example, and additionally the nonaqueous electrolytic solution including the above-described lithium salt is injected. In this way, the lithium ion secondary battery 100 is fabricated. Instead of injecting the nonaqueous electrolytic solution including the lithium salt into the case 50, the stacked body 40 may be impregnated in advance in a nonaqueous electrolytic solution including the lithium salt.

It should be noted, however, that the present disclosure is not limited to the embodiment, and that the embodiment is merely illustrative. Any and all configurations that are substantially identical, either in operation or effect, to the technical concept set forth in the claims are included in the technical scope of the present disclosure.

### EXAMPLES

### Example 1

### (Preparation of Positive Electrode)

### <Hydrothermal Synthesis Step>

23.06 g (0.20 mol) of H₃PO₄ (produced by NACALAI TESQUE, INC., purity 85%) and 200 g of distilled water (produced by NACALAI TESQUE, INC., for HPLC) were placed in a 500 ml Meyer flask (container), and the mixture was stirred with a magnetic stirrer. Subsequently, 18.37 g (0.10 mol) of V₂O₅ (produced by NACALAI TESQUE, INC., purity 99%) was added to the container and stirring was continued for about 2.5 hours. Next, 2.55 g (0.05 mol) of (NH₂NH₂XH₂O) was added dropwise to the container and stirring was continued for 1 hour. Then, 8.48 g (0.20 mol) of LiOHXH₂O (produced by NACALAI TESQUE, INC., purity 99%) was added to the container over about 10 minutes. Immediately after that, pH of a material in the container was measured, and the pH was 6. Then, 20 g of distilled water was added to obtained paste material. Subsequently, the material in the flask was transferred into a 0.5 L autoclave glass cylindrical container. The hydrothermal synthesis was performed by hermetically sealing the container, turning on a heater and maintaining the container at 200° C. for 4 hours.

After turning off the heater, cooling down was performed and the material was taken out after about 5 hours to obtain light blue paste material. When the pH of this material was measured, the pH was 7. A bout 100 ml of distilled water was added to the obtained material, and the material was heat treated at 90° C. for about 24 hours using an oven, and then pulverized. This gave 38.23 g of green powders.

### <Firing Step>

3.00 g of the solid obtained in the above step was placed in an alumina crucible and heated from room temperature to 500° C. over 50 minutes in an air atmosphere. Then, the solid was heat treated at 500° C. for 4 hours to obtain 2.73 g of yellow-green powders.

### <Re-Hydrothermal Synthesis Step>

The solid obtained in the above step and 200 g of distilled water (produced by NACALAI TESQUE, INC., for HPLC) were placed in a 500 ml Meyer flask and stirred with a magnetic stirrer. The material in the flask was transferred into a 0.5 L autoclave glass cylindrical container. The hydrothermal synthesis was performed by hermetically sealing the container, turning on the heater and maintaining the container at 150° C. for 4 hours.

After turning off the heater, cooling down was performed and the material was taken out after about 5 hours to obtain yellow-green paste material. A bout 100 ml of distilled water was added to the obtained material, and the material was heat treated at 170° C. for about 24 hours using an oven, and then pulverized. This gave green powders.

### <Measurement of Content of Crystallization Water>

The amount of crystallization water in the active material of Example 1 was measured. In this measurement, the obtained active material was measured at 170° C. by the Karl Fischer method and then measured at 300° C. by the Karl Fischer method. A measurement result at 300° C. was taken as the amount of crystallization water. The content of crystallization water in the active material of Example 1 was 0.15 wt %.

### [Preparation of Evaluation Cell]

Slurry was prepared by dispersing the active material of Example 1 and, as a binder, a mixture of polyvinylidene fluoride (PVDF) and acetylene black in N-methyl-2-pyrrolidone (NMP) as a solvent. The slurry was prepared so that a weight ratio of the active material, the acetylene black and the PVDF was 84:8:8 in the slurry. This slurry was coated on an aluminum foil as a current collector, dried and rolled. This gave an electrode (positive electrode) on which an active material layer containing the active material of Example 1 was formed.

Next, a stacked body (an element body) was obtained by stacking the obtained electrode and its counter electrode Li foil so that a separator made of a polyethylene microporous membrane was sandwiched therebetween. This stacked body was placed in an aluminum laminate pack, and electrolyte was injected into the aluminum laminate pack, followed by vacuum sealing to prepare an evaluation cell of Example 1. This electrolyte was prepared by mixing EC, PC and EMC so as to have a volume ratio of EC/PC/EMC=1/1/8 and by dissolving LiPF₆ in this mixed solution so as to have a concentration of 1.3 mol/L.

### Example 2

A battery of Example 2 was prepared and evaluated in the same manner as in Example 1 except that the heating temperature was 250° C. and heating holding time was 6 hours in the re-hydrothermal synthesis step.

### Example 3

A battery of Example 3 was prepared and evaluated in the same manner as in Example 1 except that the heating temperature was 300° C. and the heating holding time was 8 hours in the re-hydrothermal synthesis step.

### Example 4

A battery of Example 4 was prepared and evaluated in the same manner as in Example 1 except that the heating temperature was 100° C. in the re-hydrothermal synthesis step.

### Example 5

A battery of Example 5 was prepared and evaluated in the same manner as in Example 1 except that the heating temperature was 300° C. and the heating holding time was 16 hours in the re-hydrothermal synthesis step.

### Example 6

A battery of Example 6 was prepared and evaluated in the same manner as in Example 1 except that the heating temperature was 100° C. and the heating holding time was 2 hours in the re-hydrothermal synthesis step.

### Example 7

A battery of Example 7 was prepared and evaluated in the same manner as in Example 1 except that the heating temperature was 100° C. and the heating holding time was 1 hour in the re-hydrothermal synthesis step.

### Example 8

A battery of Example 8 was prepared and evaluated in the same manner as in Example 1 except that iron fluoride was input instead of V₂O₅ in the hydrothermal synthesis step.

### Example 9

A battery of Example 9 was prepared and evaluated in the same manner as in Example 1 except that cobalt sulfate was input instead of V₂O₅ in the hydrothermal synthesis step.

### Example 10

A battery of Example 10 was prepared and evaluated in the same manner as in Example 1 except that nickel phosphate was input instead of V₂O₅ in the hydrothermal synthesis step.

### Example 11

A battery of Example 11 was prepared and evaluated in the same manner as in Example 1 except that manganese oxalate was input instead of V₂O₅ in the hydrothermal synthesis step.

### Example 12

A battery of Example 12 was prepared and evaluated in the same manner as in Example 1 except that a solvent of the electrolyte was mixed to have the volume ratio of EC/PC/EMC=2/1/7 in a preparation step of the evaluation cell.

### Example 13

A battery of Example 13 was prepared and evaluated in the same manner as in Example 1 except that a solvent of the electrolyte was mixed to have the volume ratio of EC/PC/EMC=2/2/6 in the preparation step of the evaluation cell.

### Example 14

A battery of Example 14 was prepared and evaluated in the same manner as in Example 1 except that DEC was used instead of EMC in the preparation step of the evaluation cell.

### Example 15

A battery of Example 15 was prepared and evaluated in the same manner as in Example 1 except that DEC was used instead of PC in the preparation step of the evaluation cell.

### Example 16

A battery of Example 16 was prepared and evaluated in the same manner as in Example 1 except that DEC was used instead of PC, EMC to have a volume ratio of EC/DEC=3/7 in the preparation step of the evaluation cell.

### Example 17

A battery of Example 17 was prepared and evaluated in the same manner as in Example 1 except that LiOHXH₂O, V₂O₅, H₃PO₄ were input at a molar ratio of Li:V:P=3:2:3 and NH₂NH₂XH₂O was input at the same molar ratio as an input amount of V₂O₅ in the hydrothermal synthesis step.

### Comparative Example 1

A battery of Comparative Example 1 was prepared and evaluated in the same manner as in Example 1 except that the heating temperature was 750° C. and the heating holding time was 12 hours in the firing step, and the re-hydrothermal synthesis step was not performed.

### Comparative Example 2

A battery of Comparative Example 2 was prepared and evaluated in the same manner as in Example 1 except that iron fluoride was input instead of V₂O₅ in the hydrothermal synthesis step, the heating temperature was 750° C. and the heating holding time was 12 hours in the firing step, and the re-hydrothermal synthesis step was not performed.

### Comparative Example 3

A battery of Comparative Example 3 was prepared and evaluated in the same manner as in Example 1 except that cobalt sulfate was input instead of V₂O₅ in the hydrothermal synthesis step, the heating temperature was 750° C. and the heating holding time was 12 hours in the firing step, and the re-hydrothermal synthesis step was not performed.

### Comparative Example 4

A battery of Comparative Example 4 was prepared and evaluated in the same manner as in Example 1 except that nickel phosphate was input instead of V₂O₅ in the hydrothermal synthesis step, the heating temperature was 750° C. and the heating holding time was 12 hours in the firing step, and the re-hydrothermal synthesis step was not performed.

### Comparative Example 5

A battery of Comparative Example 5 was prepared and evaluated in the same manner as in Example 1 except that manganese oxalate was input instead of V₂O₅ in the hydrothermal synthesis step, the heating temperature was 750° C. and the heating holding time was 12 hours in the firing step, and the re-hydrothermal synthesis step was not performed.

Evaluation cells respectively using the active materials of Examples 2 to 17 and Comparative Examples 1 to 5 alone were prepared in the same manner as in Example 1.

### <Measurement of High-Temperature Storage Characteristics and Cycle Characteristics>

The discharge capacity when discharge rate was set to 0.1 C using each of the evaluation cells of Examples 1 to 17 and Comparative Examples 1 to 5 was measured in a thermostatic chamber of 25° C. A current value of discharge rate 0.1 C means a current value such that discharge ends in 10 hours at a constant current discharge at 25° C. Then, each evaluation cell was stored for 4 hours in the thermostatic chamber of 80° C. in a fully charged state. Thereafter, with respect to each evaluation cell, constant current discharge was performed again in the thermostatic chamber of 25° C. at a discharge rate of 0.1 C. A ratio of the discharge capacity before and after high-temperature storage at 80° C. is defined as the high-temperature storage characteristics, and results are shown in Table 1. Further, with the battery cell after measurement of the high-temperature storage characteristics, charging at 0.5 C/discharging at 1 C was repeated for 500 cycles according to the charging/discharging procedure. The charging and discharging was performed in the thermostatic chamber of 45° C. An initial discharge capacity is defined as 100%, and a value of the discharge capacity after 100 cycles is defined as the cycle characteristics. Incidentally, it is preferred that the high-temperature storage characteristics and the cycle characteristics are as large as possible. Measurement results of the cycle characteristics are shown in Table 1 as the cycle characteristics after 500 cycles.

TABLE 1

| | | Content of | High-temperature | | Re-hydrothermal | |
|---|---|---|---|---|---|---|
| | | crystallization | storage | Cycle | synthesis | Re-hydrothermal |
| | Type of active | water | characteristics | characteristics | temperature | synthesis time |
| | material | (wt %) | (%) | (%) | (éC.) | (hour) |
| Example1 | LiVOPO⁴ | 0.15 | 95% | 98% | 150 | 4 |
| Example2 | LiVOPO⁴ | 0.03 | 95% | 98% | 250 | 6 |
| Example3 | LiVOPO⁴ | 0.001 | 94% | 96% | 300 | 8 |
| Example4 | LiVOPO⁴ | 0.2 | 93% | 96% | 100 | 4 |
| Example5 | LiVOPO⁴ | 0.0005 | 91% | 93% | 300 | 16 |
| Example6 | LiVOPO⁴ | 0.23 | 92% | 94% | 100 | 2 |
| Example7 | LiVOPO⁴ | 0.35 | 91% | 93% | 100 | 1 |
| Example8 | LiFePO⁴ | 0.15 | 88% | 89% | 150 | 4 |
| Example9 | LiCoPO⁴ | 0.15 | 86% | 85% | 150 | 4 |
| Example10 | LiNiPO⁴ | 0.15 | 87% | 87% | 150 | 4 |
| Example11 | LiMnPO⁴ | 0.15 | 88% | 88% | 150 | 4 |
| Example12 | LiVOPO⁴ | 0.15 | 92% | 94% | 150 | 4 |
| Example13 | LiVOPO⁴ | 0.15 | 91% | 93% | 150 | 4 |
| Example14 | LiVOPO⁴ | 0.15 | 88% | 90% | 150 | 4 |
| Example15 | LiVOPO⁴ | 0.15 | 89% | 91% | 150 | 4 |
| Example16 | LiVOPO⁴ | 0.15 | 87% | 87% | 150 | 4 |
| Example17 | Li³V²(PO⁴)³ | 0.15 | 88% | 89% | 150 | 4 |
| Comparative | LiVOPO⁴ | 0 | 78% | 78% | [symbol] | [symbol] |
| Example1 | | | | | | |
| Comparative | LiFePO⁴ | 0 | 69% | 69% | [symbol] | [symbol] |
| Example2 | | | | | | |
| Comparative | LiCoPO⁴ | 0 | 60% | 60% | [symbol] | [symbol] |
| Example3 | | | | | | |
| Comparative | LiNiPO⁴ | 0 | 62% | 62% | [symbol] | [symbol] |
| Example4 | | | | | | |
| Comparative | LiMnPO⁴ | 0 | 73% | 73% | [symbol] | [symbol] |
| Example5 | | | | | | |

As can be seen from the results in Table 1, it was confirmed that Examples 1 to 17 have excellent high-temperature storage characteristics and high cycle characteristics since crystallization water is contained in a crystal lattice.

The foregoing detailed description has been presented for the purposes of illustration and description. Many modifications and variations are possible in light of the above teaching. It is not intended to be exhaustive or to limit the subject matter described herein to the precise form disclosed. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims appended hereto.

What is claimed is:

1. A positive electrode active material comprising a compound represented by general formula (1) below, wherein
the compound contains crystallization water.
LiₐM_{b}(PO₄)_{c} ρ (1)
(M includes at least one selected from Fe, Mn, Co, Ni, VO, V, and 1 [symbol] a [symbol] 4, 1 [symbol] b [symbol] 2, 1 [symbol] c [symbol] 3)

2. The positive electrode active material according to claim 1, wherein a content of the crystallization water is 0.001 to 0.2 wt %.

3. The positive electrode active material according to claim 1, wherein M is VO in the general formula (1).

4. The positive electrode active material according to claim 2, wherein M is VO in the general formula (1).

5. A positive electrode comprising the positive electrode active material according to claim 1.

6. A lithium ion secondary battery comprising the positive electrode according to claim 5, a negative electrode and an electrolyte.

7. The lithium ion secondary battery according to claim 6, comprising, as a nonaqueous solvent, at least one selected from propylene carbonate (PC) and ethyl methyl carbonate (EMC).
